(19) United States
(12) Patent Application Publication
(10) Pub. No.: US 2008/0263366 A1
(43) Pub. Date: Oct. 23, 2008

(54) SELF-VERIFYING SOFTWARE TO PREVENT REVERSE ENGINEERING AND PIRACY

(75) Inventor: Mauruthi G, Chennai (IN)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 11/737,611

(22) Filed: Apr. 19, 2007

(51) Int. Cl. G06F 12/14

(52) U.S. Cl. 713/190

(57) ABSTRACT

Reverse engineering and piracy of software is prevented by encrypting code blocks of a program. A program is modified to include additional protective code, including a protective code launcher which is launched with the program. Decryption and execution code is also provided for the protective code launcher and one or more code blocks of the program. A given code block is encrypted using a key which is based on a previous code block, and the previous code block is encrypted using a key which is based on a further previous code block, and so forth. If a hacker modifies the program, such as to avoid a message which requires the user to purchase the program, the program will be disabled. The program can also be encrypted based on computer hardware such as a hard disk serial number so that it will only operate on a particular computer.

### BACKGROUND

Software piracy hurts software developers, retailers and users. Worldwide, the economic loss associated with software piracy is estimated in the tens of billions of dollars. Software can often be compromised by a hacker, such as through reverse engineering. A hacker can modify a program such as to bypass a shareware nag message, which prompts a user to purchase software which has been used in a trial period for no charge, or to enable a disabled feature of the software. Further, the hacker can supply patch files for disabling anti-piracy features to others via the Internet, thereby compounding the problem.

Existing anti-piracy techniques include providing software with the ability to check itself during load time to see if it has been modified, or providing serial key based registration, in which the user is prompted to enter a registration code before running the software. However, these methods are not completely reliable because a hacker can modify the relevant portion of the software to bypass the enforcement mechanism.

A solution is needed for preventing, or increasing the difficulty of, reverse engineering and piracy of software which addresses the above and other issues.

### SUMMARY

Techniques are provided for preventing reverse engineering and piracy of software by preventing execution of the software when it is modified by a hacker.

In one aspect, a computer-implemented method for protecting software includes adding decrypting and executing code to a program to be protected, where the program includes one code block which is executed during a runtime of the program. The method also includes encrypting the one code block using a key which is based partially or totally on another code block to provide an encrypted one code block. The decrypting and executing code includes: (a) code for decrypting the encrypted one code block to provide a decrypted one code block and (b) code for executing the decrypted one code block. The method further includes deploying the program, such as by allowing a user to download the program from a server to the user's host computer, or storing the program on a computer readable media such as a CD-ROM for sale in a retail store, for instance. The code can include, e.g., source code in plain text, instructions, byte code, intermediate code or instructions or a combination thereof.

In another aspect, a computer-implemented method for running protected software includes receiving a request to launch a program and, based on the request, decrypting an encrypted particular code block and encrypted particular protective code of the program to provide a decrypted particular code block and decrypted particular protective code, respectively. The method further includes executing the decrypted particular code block and executing the decrypted particular protective code. The particular protective code decrypts an encrypted additional code block of the program, thereby providing a decrypted additional code block, and executes the decrypted additional code block.

In another aspect, a computer readable media having computer readable software embodied thereon is provided for programming at least one processor to perform a method, where the method includes encrypting parts of the software using a key totally or partially based other parts of the software, decrypting the encrypted software at runtime to provide a decrypted part of the software, and executing the decrypted software where parts of the software include parts of the software in one or more files, or byte code or intermediate code or source code or code blocks or instructions which are executed at runtime.

This summary is provided to introduce a selection of concepts in a simplified form that are further described below in the description. This summary is not intended to identify key features or essential features of the claimed subject matter, nor is it intended to be used to limit the scope of the claimed subject matter.

### BRIEF DESCRIPTION OF THE DRAWINGS

FIG. 1a depicts an original, unmodified program.

FIG. 1b depicts the program of FIG. 1a with anti-piracy code removed.

FIG. 1c depicts the program of FIG. 1a with anti-piracy code bypassed.

FIG. 1d depicts a process for adding protective code to a program.

FIG. 2 depicts a first process for encrypting code blocks to create self-verifying software.

FIG. 3 depicts a first process for decrypting code blocks which corresponds to FIG. 2.

FIG. 4 depicts a second process for encrypting code blocks to create self-verifying software.

FIG. 5 depicts a second process for decrypting code blocks which corresponds to FIG. 4.

FIG. 6a depicts a flowchart of pre-deployment processing corresponding to FIGS. 2 and 4.

FIGS. 6b-d depict alternative pre-deployment processing.

FIG. 7 depicts a flowchart of runtime processing corresponding to FIG. 3.

FIG. 8 depicts a flowchart of runtime processing corresponding to FIG. 5.

FIG. 9 depicts a flowchart of pre-deployment processing in which runtime data is used in an encryption key.

FIG. 10 depicts a flowchart of runtime processing in which runtime data is used in a decryption key.

FIG. 11 depicts a flowchart of an anti-piracy process which restricts execution of a program based on computer hardware.

FIG. 12 is a block diagram of computer hardware suitable for implementing embodiments of the invention.

### DETAILED DESCRIPTION

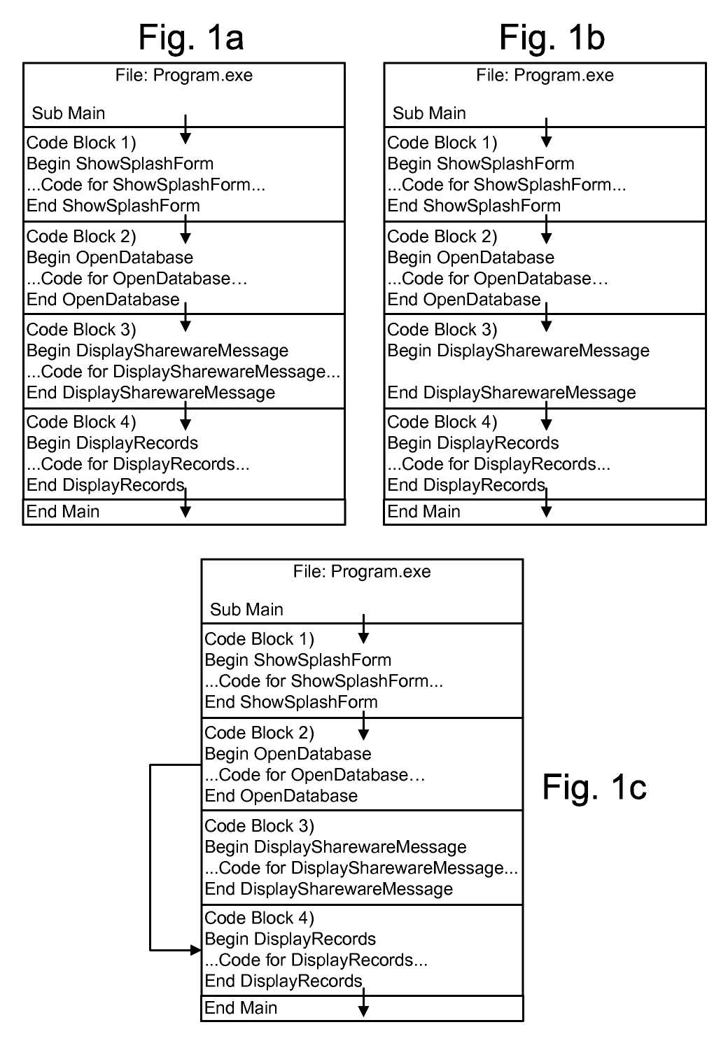

Reverse engineering and piracy of software can be thwarted by preventing execution of the software when it is modified by a hacker. For example, FIG. 1a depicts an original, unmodified program. The program file name is “Program.exe,” indicating that the program is an executable, in one example implementation. An executable is a computer program that can run on its own. A sub main portion of the program includes a number of code portions such as code blocks. A code block includes, e.g., instructions which are meant to be executed as a group. A code block can be but is not limited to a piece of instruction set for running the software or byte code/compiled code/intermediate code that can be executed dynamically, or even source code in text. For the sake of clarity, code blocks are displayed as text. For example, a first code block includes code for a “ShowSplashForm.” A splash form or screen is the initial view that a user sees when a program is loading. For example, this may be a screen which identifies the developer of the program. A second code block includes code for “OpenDatabase,” which, e.g., accesses a database for running the program. The third code block includes code for “DisplaySharewareMessage,” which displays a shareware nag message. This type of message is commonly used with shareware, and is a functionality which requires a user to provide an authorization to use the program. Shareware is software that is distributed free on a trial basis with the understanding that the user may need or want to pay for it later. Some software developers offer a shareware version of their program with a built-in expiration date after which the user can no longer get access to the program. Other shareware is offered with certain capabilities disabled as an enticement to buy the complete version of the program. The shareware nag message may prompt the user to buy the software, for instance, or to enter information such as a registration code which only an authorized user would have. A shareware nag message is typically provided on screen but can also be provided in an output such as a hardcopy printout.

If the user successfully responds to the shareware nag message, a fourth code block for “DisplayRecords” executes. Thus, the nag message may require the user to provide an authorization such as a registration code to use the program in order to have the program continue to execute or in order to access the program's full functionality. If the user does not successfully responds to the shareware nag message, the program may terminate. The fourth code block can display other information to the user, for instance.

A hacker can modify the software to either bypass or remove the shareware nag message, in one possible piracy technique. This destroys the very purpose of the shareware, namely prompting the user to buy the complete software. Moreover, with a little more effort and time, an experienced hacker can reverse engineer software to defeat other anti-piracy techniques such as those which use a hash key to determine whether the software has been modified.

For example, FIG. 1b depicts the program of FIG. 1a with anti-piracy code removed. Here, the code for “DisplaySharewareMessage” in the third code block has been removed so that only beginning and ending portions of the code remain. In this case, the program would proceed to execute the fourth code block without requiring the user to enter the required authorization information. Another approach a hacker might take is shown in FIG. 1c, which depicts the program of FIG. 1a with anti-piracy code bypassed. Here, the hacker modifies the second code block to transition to the fourth code block, bypassing the third code block altogether. These figures are intended to be an example. For example, the hacker would typically change the flow of execution by modifying the instruction pointer passed to the JMP instruction.

FIG. 1d depicts a process for adding protective code to a program. An original program which is unencrypted (block 100) is processed by protective code insertion software (block 110). The original program and the protective code which is inserted are then processed by an encryption engine (block 120) to produce the original code and protective code in an encrypted form (block 130). Optionally, the protective code is not encrypted.

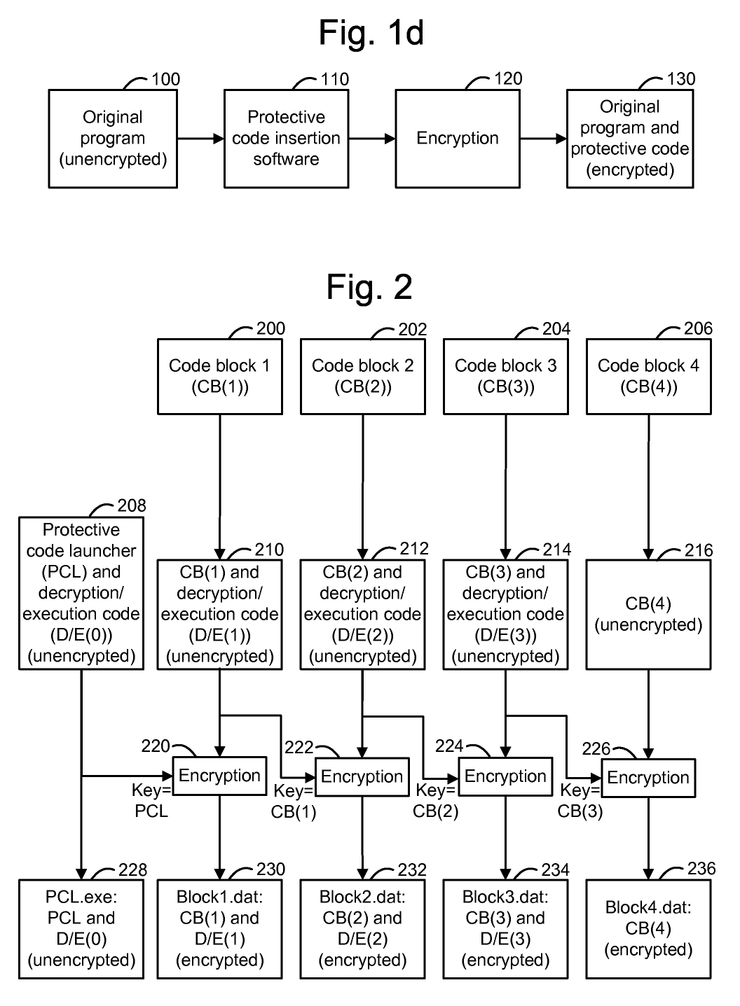

In further detail, FIG. 2 depicts a first process for encrypting code blocks to create self-verifying software, that is, software that can verify itself as it executes and can stop executing if a verification check is not successful. One approach to creating self-verifying software involves encrypting parts of the software using other parts of the software as a key. The parts of the software can include bytes of software which are stored on a disc or other storage medium, and/or can be but not limited to code or instruction sets that can be executed dynamically, which correspond to modules of the software. Further, the encryption can be performed at the time of creation of the software by the developer or by an automated program. With this approach, if one part of the software is reverse engineered, such as by altering a byte to remove the shareware nag message, the other parts of the software cannot be decrypted, because the key (the part of the software that has been reverse engineered) has changed. Thus a verification check failure means that other parts of the software couldn't be decrypted in order to be executed.

Here, code blocks 1 through 4 are depicted by the notation CB(1) through CB(4), respectively (blocks 200, 202, 204 and 206). Four code blocks are illustrated for simplicity but, in practice, a typical program can include many code blocks. A new module (block 208), referred to as a protective code launcher (PCL), along with decryption/execution code (D/E(0)), is added to the original program. The PCL can be an executable file which is executed when the program (see, e.g., Program.exe, FIG. 1a) is launched by a user. D/E(0) is code which can be appended to PCL to decrypt and execute, e.g., run, CB(1) dynamically during a runtime of the program. Here the code which is appended can be instruction sets/compiled code/byte code/intermediate code/source code which can be executed dynamically (e.g., on the fly during runtime of the program). Additionally, CB(1), CB(2) and CB(3) are modified to include decryption/execution code D/E(1), D/E(2) and D/E(3), respectively, as indicated by blocks 210, 212, 214 and 216, respectively. For example, D/E(1), D/E(2) and D/E(3) can be appended to the respective code blocks CB(1), CB(2) and CB(3), respectively, so that they are executed after the respective code blocks are executed. D/E(1) includes code for decrypting and executing CB(2), D/E(2) includes code for decrypting and executing CB(3) and D/E(3) includes code for decrypting and executing CB(4). The decrypting and executing may be performed dynamically, during runtime of the program. The code blocks and decryption/execution code are unencrypted initially, in one approach. D/E(0), D/E(1), D/E(2) and D/E(3) may be considered to be protective code.

Encryption takes place at encryption engines 220, 222, 224 and 226. In practice, only one encryption technique need be used as the encryption need not be simultaneous. It is also possible to use different encryption techniques for different code blocks or sets of code blocks and decryption/execution code. For example, a small change to one of the variables used inside an encryption or decryption algorithm, such as the substitution boxes (S-boxes) can be made. S-boxes are found in many block ciphers, including those which follow the Data Encryption Standard. Different numbers of rounds of encryption can also be used for different code blocks. Essentially any type of encryption technique can be used. Combination of the above approaches can also be used.

Moreover, the code blocks can be present as different files on a storage media such as a disc, or they can be clubbed together in one or more files. If more than one code block is stored in a single file, the different code blocks can be differentiated from one another in different ways. For example, the length in bytes of each code block can be stored before every code block so that the end of the code block can be identified. Or, an index can be included at the start of the file which identifies the position of each code block. In another approach, the encrypted code block is placed inside the previous code block until the top of the chain is reached. The examples given above are for purposes of illustration and description. Various other approaches may be used as well.

The encryption engine may be external to the program which is being protected. Encryption may begin with the highest numbered code block and proceed, block by block, to the lowest numbered block, in one possible approach. In particular, CB(4), which does not include decryption/execution code because it is the last code block. In one approach, D/E(3) is appended to CB(3). D/E(3) contains code to decrypt CB(4) using CB(3) as the key and execute the decrypted CB(4). CB(4) is encrypted at encryption engine 226 using a key which is based on CB(3), to provide CB(4) in encrypted form in a data file Block4.dat (block 236). For example, the key may be the contents of CB(3) itself or some portion thereof, such as the first n bytes, or so forth. Or, the key may be a function of CB(3), such as a hash function. The key may also be contents of CB(3) +D/E(3). One may wonder how D/E(3) can both contain code to decrypt CB(4) as well as being part of the key to encrypt/decrypt it. This is possible because, at the basic level, D/E(3) may be just raw data (such as a file in the disk). Using this data as the key, CB(4) is encrypted. When loaded in memory, D/E(3) may serve as a function to decrypt. For example, after D/E(3) is loaded in memory, it may use the file present on the disk (CB(3) +D/E(3)) as the key to decrypt CB(4). Various other approaches may be used as well.

Next, CB(3) and D/E(3) are encrypted at encryption engine 224 using a key which is based on CB(2), to provide CB(3) and D/E(3) in encrypted form in a file Block3.dat (block 234). Next, CB(2) and D/E(2) are encrypted at encryption engine 222 using a key which is based on CB(1), to provide CB(2) and D/E(2) in encrypted form in a file Block2.dat (block 232). Lastly, CB(1) and D/E(1) are encrypted at encryption engine 220 using a key which is based on PCL, to provide CB(1) and D/E(1) in encrypted form in a file Block1.dat (block 230). PCL and D/E(0) are provided again in unencrypted form at block 228 in a file PCL.exe, although it is possible to also encrypt them.

Note that the above processing may occur before the software is deployed, in a pre-deployment phase. Once the protective software has been added to the program and the program has been modified, it can be deployed knowing that it is safe from hackers.

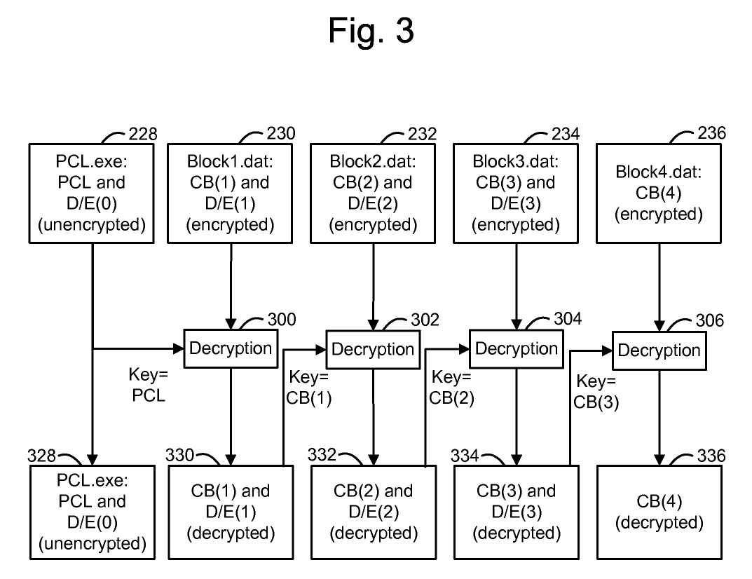

FIG. 3 depicts a first process for decrypting code blocks which corresponds to FIG. 2, e.g., in a process that is performed by the self-verifying software. Like numbered elements correspond to those in FIG. 2. During a runtime of the program, the user runs the main executable which contains the Program Code Launcher (PCL). The D/E(0) code decrypts Block1.dat using the main executable file PCL as the key, in one possible approach, and then runs the decrypted code, CB(1), dynamically. After the original instructions, e.g., CB(1), in Block1.dat have been executed, the extra protective code, e.g., D/E(1), that has been added to decrypt and run Block2.dat, will execute. This time, CB(1) will be used as the key to decrypt Block2.dat. The process of running a code block, decrypting the next code block and running the decrypted code block will continue until the last code block has been executed.

In the present example, decryption takes place at decryption engines 300, 302, 304 and 306. In practice, only one decryption technique need be used as the decryption need not be simultaneous. Different decryption techniques may be used in correspondence with different encryption techniques for the different code blocks and decryption/execution code. Decryption may begin with the lowest numbered block and proceed, block by block, to the highest numbered block. In particular, CB(1) and D/E(1) are decrypted at decryption engine 300 using a key which is based on PCL, to provide CB(1) and D/E(1) in decrypted form (block 330). CB(2) and D/E(2) are decrypted at decryption engine 302 using a key which is based on CB(1) in decrypted form, to provide CB(2) and D/E(2) in decrypted form (block 332). CB(3) and D/E(3) are decrypted at decryption engine 304 using a key which is based on CB(2) in decrypted form, to provide CB(3) and D/E(3) in decrypted form (block 334). Finally, CB(4) is decrypted at decryption engine 306 using a key which is based on CB(3) in decrypted form, to provide CB(4) in decrypted form (block 336). PCL and D/E(O) are provided again in unencrypted form at block 328, although it is possible to also decrypt them if they were previously encrypted (in this case the part of the operating system that deals with loading and running executables in memory, will have code to decrypt and run it).

Hacking of the program is prevented or restricted to the maximum with this approach. For example, in order to remove the DisplaySharewareMessage, the hacker has to first run the executable and then get the decrypted data from memory. Then the hacker has to modify the corresponding bytes in the file to prevent the message from being displayed. Then the hacker has to re-encrypt the file Block3.dat with CB(2) as the key. On the other hand, if the hacker does modify the file Block3.dat, it will not be executed because code in Block2.dat will not be able to decrypt it because the key to decrypt it has been modified. Even if the hacker manages to modify all the blocks above Block3.dat, Block4.dat will not execute because the key used to encrypt it (CB(3) in its original unmodified form) is different from the one which is being used to decrypt it (CB(3) in its modified form). Thus the hacker has to modify all the blocks of code in order to defeat the shareware nag message or other anti-piracy code. This process is quite tedious considering that a typical software program will have hundreds if not thousands of such code blocks and it will be easier for the hacker to create a new program rather than hack or reverse engineer the protected program.

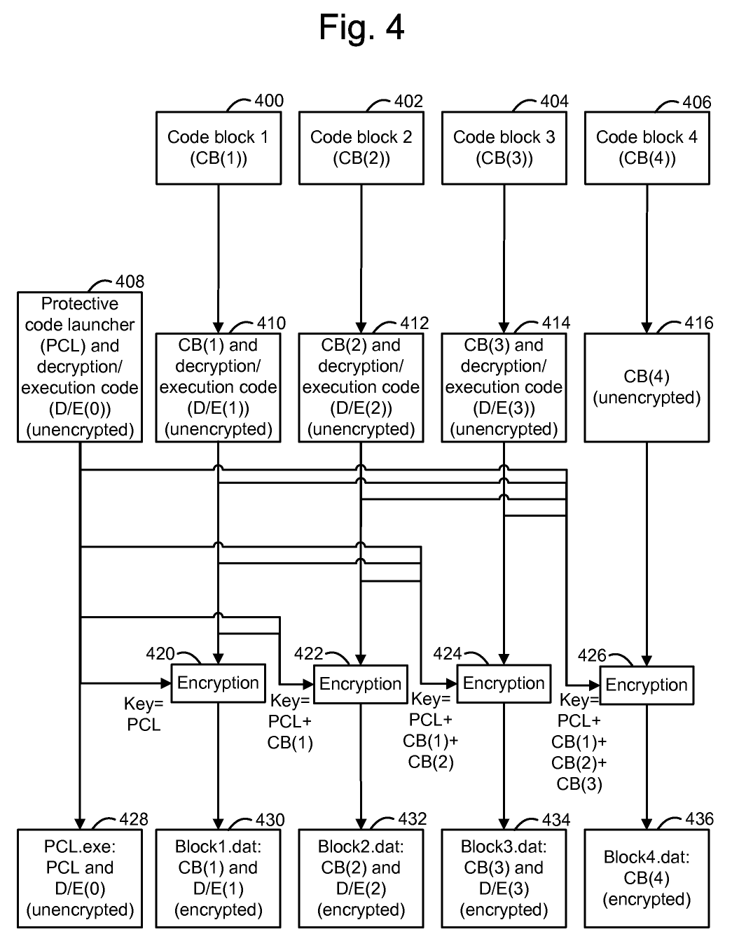

FIG. 4 depicts a second process for encrypting code blocks to create self-verifying software. In this approach, each code block is encrypted using a key which is based on all of the previous code blocks. That is, the effectiveness of the key is increased by using not only the immediate previous code block for encrypting, but also appending the previous code blocks and the main executable file (PCL.exe) to the key. It can also be a hash derived from all the previous code blocks. Thus, even if the hacker manages to crack one or two code blocks, the remaining code blocks will not execute because each code block requires all other code blocks above its flow of execution, in order to be decrypted. In another approach, rather than using all previous blocks as the encryption key, the number of previous blocks used may be capped at a maximum to reduce processing time.

By analogy to the discussion of FIG. 2, CB(1), CB(2), CB(3) and CB(4) (blocks 400, 402, 404 and 406, respectively) are modified to include decryption/execution code D/E(1), D/E(2), D/E(3) and D/E(4), respectively, as indicated by blocks 410, 412, 414 and 416, respectively. The protective code launcher (PCL) and the decryption/execution code (D/E(0)) are provided at block 408.

Encryption takes place at encryption engines 420, 422, 424 and 426. In practice, only one encryption technique need be used as the encryption need not be simultaneous. Further the encryption engine may be external to the program which is being protected. Encryption may begin with the highest numbered block and proceed, block by block, to the lowest numbered block. In particular, CB(4) is encrypted at encryption engine 426 using a key which is based on PCL, CB(1), CB(2) and CB(3) to provide CB(4) in encrypted form in the file Block4.dat (block 436). For example, the key may be formed by concatenating the bytes of PCL, CB(1), CB(2) and CB(3), or some portion of the bytes of PCL, CB(1), CB(2) and CB(3), such as the first n bytes, or so forth. Or, the key may be a function of PCL, CB(1), CB(2) and CB(3), such as a hash function. Also, one or more rounds of encryption may be used. Various other approaches may be used as well. Generally, there is a trade off between speed of execution, size of the executable, complexity of applying the technique in the software and level of protection required.

Next, CB(3) and D/E(3) are encrypted at encryption engine 424 using a key which is based on PCL, CB(1) and CB(2), to provide CB(3) and D/E(3) in encrypted form in the file Block3.dat (block 434). Next, CB(2) and D/E(2) are encrypted at encryption engine 422 using a key which is based on PCL and CB(1), to provide CB(2) and D/E(2) in encrypted form in the file Block2.dat (block 432). Lastly, CB(1) and D/E(1) are encrypted at encryption engine 420 using a key which is based on PCL, to provide CB(1) and D/E(1) in encrypted form in the file Block1.dat (block 430). PCL and D/E(0) are provided again in unencrypted form at block 428 in a file PCL.exe, although it is possible to also encrypt them. Note that the above processing may occur before the software is deployed.

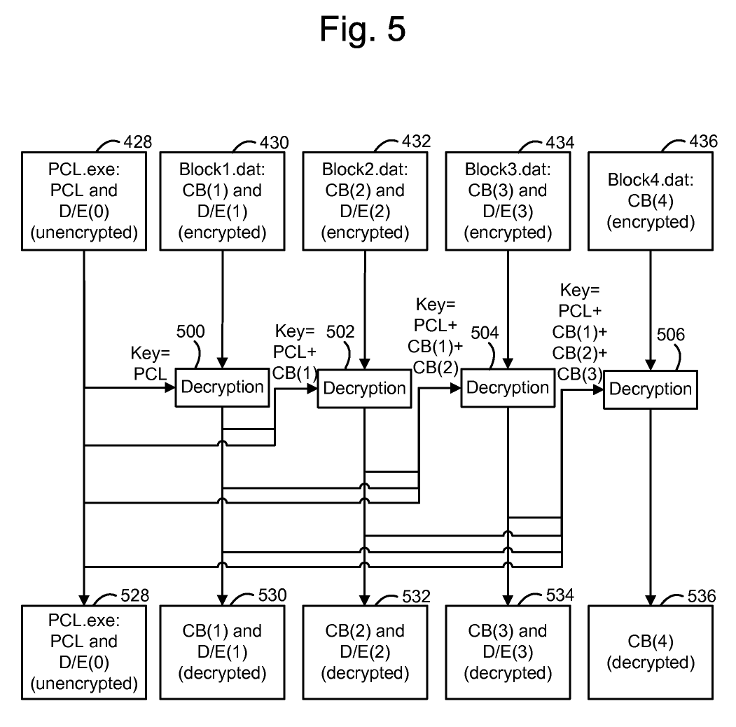

FIG. 5 depicts a second process for decrypting code blocks which corresponds to FIG. 4. Like numbered elements correspond to those in FIG. 4. During a runtime of the program, the user runs the main executable which contains the Program Code Launcher (PCL). The PCL uses the D/E(0) code to decrypt Block1.dat using the main executable file PCL as the key, in one possible approach, and then run the decrypted code, CB(1), dynamically. After CB(1) has executed, D/E(1) executes. This time, PCL and CB(1) will be used to provide the key to decrypt Block2.dat. The process of running a code block, decrypting the next code block and running the decrypted code block will continue until the last code block has been executed.

In the present example, decryption takes place at decryption engines 500, 502, 504 and 506. In practice, only one decryption technique need be used as the decryption need not be simultaneous. Decryption may begin with the lowest numbered block and proceed, block by block, to the highest numbered block. In particular, CB(1) and D/E(1) are decrypted at decryption engine 500 using a key which is based on PCL, to provide CB(1) and D/E(1) in decrypted form (block 530). CB(2) and D/E(2) are decrypted at decryption engine 502 using a key which is based on PCL and CB(1) in decrypted form, to provide CB(2) and D/E(2) in decrypted form (block 532). CB(3) and D/E(3) are decrypted at decryption engine 504 using a key which is based on PCL, CB(1) and CB(2) in decrypted form, to provide CB(3) and D/E(3) in decrypted form (block 534). Finally, CB(4) is decrypted at decryption engine 506 using a key which is based on PCL, CB(1), CB(2) and CB(3) in decrypted form, to provide CB(4) in decrypted form (block 536). PCL and D/E(0) are provided again in unencrypted form at block 528, although it is possible to also decrypt them if they were previously encrypted.

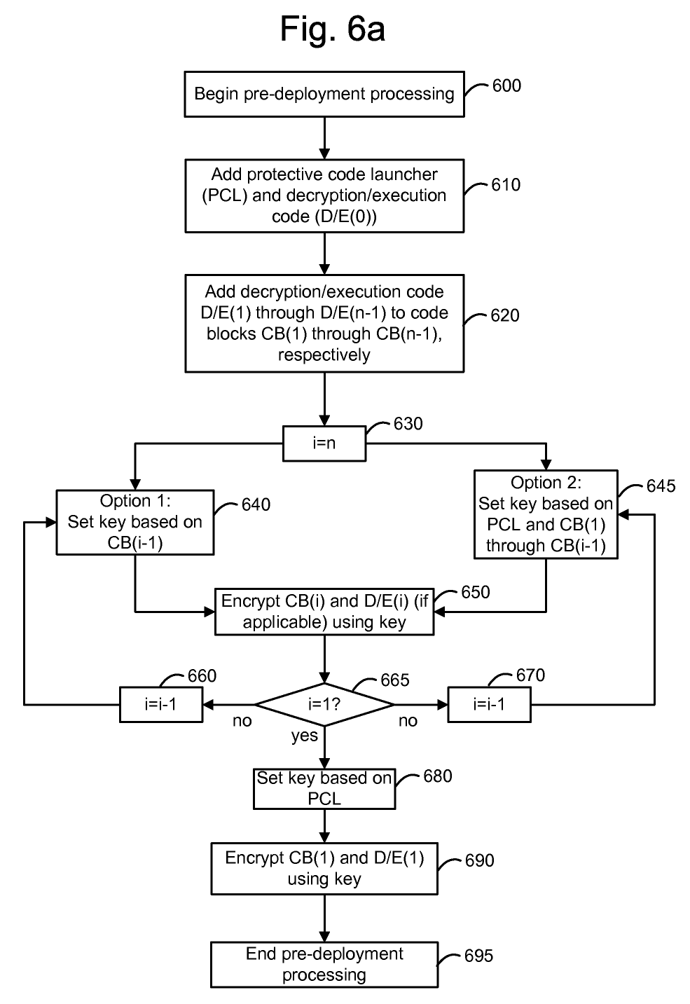

FIG. 6a depicts a flowchart of pre-deployment processing corresponding to FIGS. 2 and 4. Pre-deployment processing can occur prior to deploying the program, such as by allowing a user to download the program from a server to the user's computer, or storing the program on a computer readable media such as a CD-ROM for sale in a retail store, for instance. The pre-deployment processing begins at step 600. At step 610, the Protective Code Launcher (PCL) and the decryption/execution code D/E(0) is added to the program to be protected. For example, these may be provided in an executable file which executes when the program is launched. The PCL essentially launches the protective code starting with the decryption/execution code DE(0). At step 620, decryption/execution code DE(1) through DE(n-1) is provided for code blocks CB(1) through CB(n-1), respectively, where n is the number of protected code blocks.

At step 630, an index i is initialized to n. Next, a first option can be followed which corresponds to the process of FIG. 2 or a second option can be followed which corresponds to the process of FIG. 4. In the first option, a key is set based on CB(i−1) at step 640, that is, the block prior, in execution order, to the current block which is to be encrypted. At step 650, CB(i) and D/E(i) are encrypted using the key. Recall that the last (nth) block need not include decryption/execution code. Thus, only CB(n) need be encrypted when i=n.

The key can include the byte code or the instruction set for every code block that is used to encrypt the next code block. One approach is to use strings which can be interpreted dynamically using a mechanism such as System.Reflection of the Microsoft .Net Framework. This mechanism provides an API which allows dynamic execution of code. For example, the source code for a code block can be parsed and run dynamically at runtime using System.Reflection. Generally, any suitable operating system or programming language can be used. Further, the code which is executed can be, e.g., source code or compiled byte code/interpreted code/intermediate code.

At decision step 665, if i has not yet been decremented to 1, it is decremented at step 660 and the key is set again at step 640 to encrypt the next lower code block and decryption/execution code at step 650. This cycle is repeated until i=1 at decision step 665. At this point, CB(2) through CB(n) and D/E(2) through D/E(n) have been encrypted. At step 680, a key is set based on PCL. Subsequently, at step 690, the first code block and decryption/execution code, CB(1) and D/E(1), respectively, are encrypted using the key, and the pre-deployment processing ends at step 695.

In the second option, a key is set based on PCL and CB(1) through CB(i−1) at step 645. In the first pass, with i=n, the key is set based on PCL and CB(1) through CB(n−1). At step 650, CB(i) and D/E(i) are encrypted using the key. At decision step 665, if i has not yet been decremented to 1, it is decremented at step 670 and the key is set again at step 645 to encrypt the next lower code block and decryption/execution code at step 650. This cycle is repeated until i=1 at step 665. At this point, CB(2) through CB(n) and D/E(2) through D/E(n) have been encrypted. Processing continues at step 680 as discussed previously.

Note that in an alternative approach, the decryption/execution code is not encrypted. Also, it is not necessary to encrypt every code block in a program, as only selected code blocks can be encrypted. Further, the selected code blocks can be chosen in a random manner or according to some other prescribed sequence to make it harder for a hacker to locate them. Each encrypted code block can include information which identifies the next encrypted code block, e.g., based on an offset of a number of code blocks or based on some other identifier of the next encrypted code block, such as its name. The fact that most of the programs don't consist of a single path of execution is also be taken into consideration. Consider the flow of execution depicted in FIG. 6b for example. From CB(2), the flow of execution can either go to CB(3) or CB(4). In this case, CB(2) would contain both D/E(3) and D/E(4). Both CB(3) and CB(4) will be encrypted using CB(3)+CB(2)+CB(1)+PCL as the key. Similarly CB(6) will be encrypted using CB(3)+CB(2)+CB(1)+PCL as the key. CB(3) will contain D/E(6) and D/E(7) and D/E(8), selectively running one of them depending on which code block needs to be executed. In one approach, instead of using the code blocks along the flow of execution, code blocks from other path of flow of execution can be used as a key to encrypt. These scenarios may involve appending a flag to the code block to indicate the code block with which it was encrypted.

It is not necessary to encrypt all code blocks. Depending on the level of protection required, only some of the code blocks need to be encrypted. In some situations, the same code block might need to be called from other different code blocks. Take, for example, in an extension to FIG. 6b, CB(15) might need to be called both from CB(13) and CB(14). One solution is to create a copy of CB(15), store it as CB(16) as described in FIG. 6c. Another solution is to encrypt CB(15) using CB(13). Along with the encrypted CB(15), we can store a flag indicating that it should be decrypted using CB(13) as the key, as depicted in FIG. 6d. In this case, CB(14) will read the flag in the encrypted CB(15) and use CB(13) to decrypt CB(15) instead of itself. Other variations may include encrypting CB(15) using parts of CB(13) and CB(14) and including flags which describe that CB(15) should be decrypted using both CB(13) and CB(14) as the keys. Various other approaches may be used as well.

The protective code can be added to a program by having the developer modify the program (e.g., an executable/application). For example, the developer can manually use external encryption software to encrypt the code blocks and then write code in each code block for decrypting the next code block. In another approach, a program such as a compiler can be programmed to automatically produce an executable which includes the protective code. The executable format can follow any specification depending on the operating system with which it is intended to work. Moreover, an external program can be developed which analyzes the code blocks and includes code or byte code automatically to apply the technique. In a semi-automatic approach, external software is used to encrypt the code blocks and the compiler of the source code can add the code necessary to perform decryption.

Further, any file that contains data, including media files (e.g., including audio and/or video data content), can be protected from being modified using the anti-piracy techniques provided herein. Typically, when a file other than an executable is opened, the application designed to open that specific file type launches and opens the file. To prevent the file from being modified, the file can be converted into an executable that runs on its own. For example, an image file or other data content file can be modified into an executable that will both contain the logic required to open or otherwise access an image or other content as well as the data of the image or other content. For example, the data of an icon file (where the icon is an image) can be stored in an array of integers within the program and a function can be written to read this array at runtime and display the icon on the screen. The array may be stored locally inside the same function or globally in the program. One way of applying the technique is to encrypt this function using another function used for launching the program. Thus both data and logic to display the icon are encrypted. Also, this technique can be combined with a technique for restricting access based on computer hardware, discussed below, to restrict music file, movies and other media files (or any file type) from being run or open on an unauthorized computer. Components/files, such as, but not limited to, dynamic link libraries (DLLs) and OCXs, which are invoked by executables, can also be protected. OCX refers to an Object Linking and Embedding (OLE) control extension, which is an independent program module that can be accessed by other programs in a Windows environment. Any code or instruction set that can be loaded to memory and executed can be protected using this technique. Hence even the core operating system can be protected using this technique.

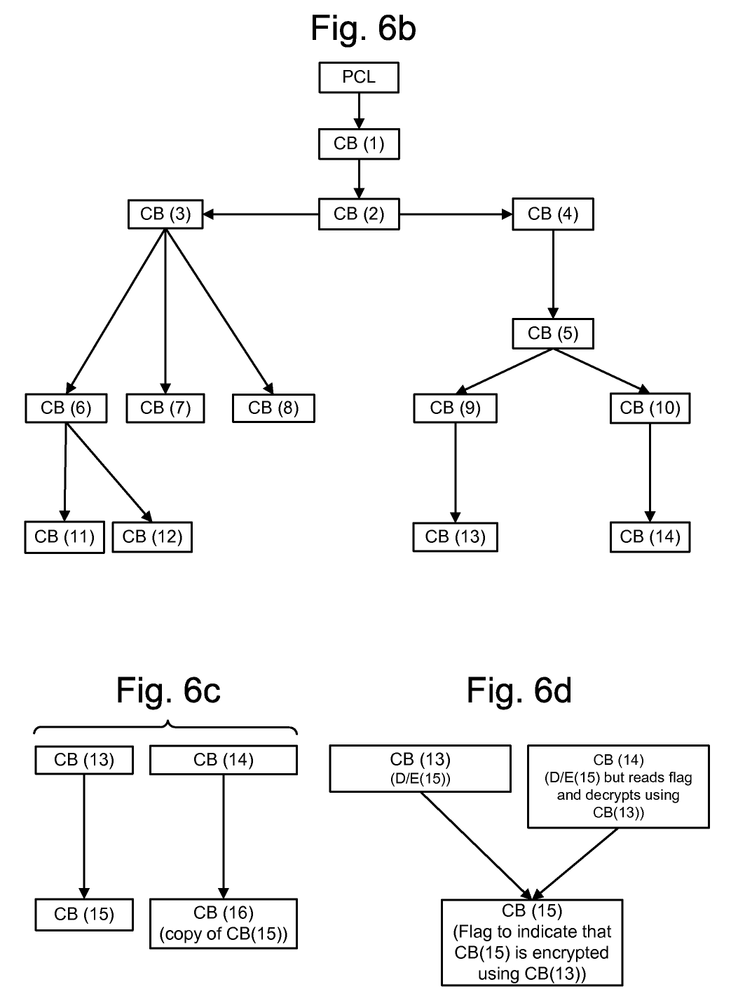

FIG. 7 depicts a flowchart of runtime processing corresponding to FIG. 3. At step 700, the user launches the protected program, e.g., in a conventional manner. It is also possible for the protective code launcher to be launched when another part of the program is executed, such as when a particular feature of the software is called. In response, at step 710, the protective code launcher (PCL) launches the decryption/execution code (D/E(0)). At step 720, the decryption code of D/E(0) sets a key based on PCL, e.g., the key can include all or a portion of PCL or can be based on a function of PCL such as a hash function. At step 730, the decryption code of D/E(0) decrypts CB(1) and D/E(1) based on the key. At step 740, the execution code of D/E(0) executes the decrypted CB(1) and D/E(1). D/E(1) may be executed after CB(l) is executed. At step 750, an index i is initialized to one. At step 760, the decryption code of D/E(i) sets a key based on CB(i). At step 770, the decryption code of D/E(i) decrypts CB(i+1) and D/E(i+1) based on the key. At step 780, the execution code of D/E(i) executes the decrypted CB(i+1) and D/E(i+1). At decision step 790, if i has not yet been incremented to n−1, it is incremented at step 785 and processing continues at steps 760, 770 and 780 as discussed for the next higher block. When i=n−1 at decision step 790, the original program is fully decrypted (step 795).

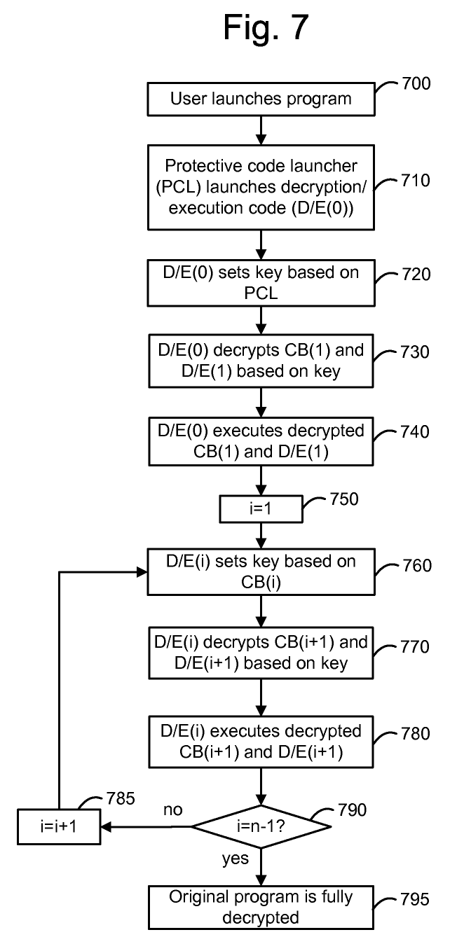

FIG. 8 depicts a flowchart of runtime processing corresponding to FIG. 5. Steps 800 and 810 correspond to steps 700 and 710, respectively, of FIG. 7. At step 820, the decryption code of D/E(0) sets a key based on PCL, e.g., the key can include all or a portion of PCL or can be based on a function of PCL such as a hash function. Additionally, PCL is stored for later use. At step 830, the decryption code of D/E(0) decrypts CB(1) and D/E(1) based on the key, and stores the decrypted CB(1). At step 840, the execution code of D/E(0) executes the decrypted CB(1) and D/E(1). At step 850, an index i is initialized to one. At step 860, the decryption code of D/E(i) sets a key based on PCL and CB(1) through CB(i). With i=1, the decryption code of D/E(i) sets a key based on PCL and CB(1). The previously stored PCL and CB(1) values can be retrieved and used for this purpose.

At step 870, the decryption code of D/E(i) decrypts CB(i+1) and D/E(i+1) based on the key and stores CB(i+1). At step 880, the execution code of D/E(i) executes the decrypted CB(i+1) and D/E(i+1). At decision step 890, if i has not yet been incremented to n, it is incremented at step 885 and processing continues at steps 860, 870 and 880 as discussed for the next higher block. For example, with i=2, D/E(2) sets a key based on PCL and CB(1) through CB(2) at step 860. D/E(2) decrypts CB(3) and D/E(3) based on the key and stores CB(3) at step 870. D/E(2) executes the decrypted CB(3) and D/E(3) at step 880. When i=n at decision step 890, the original program is fully decrypted (step 895).

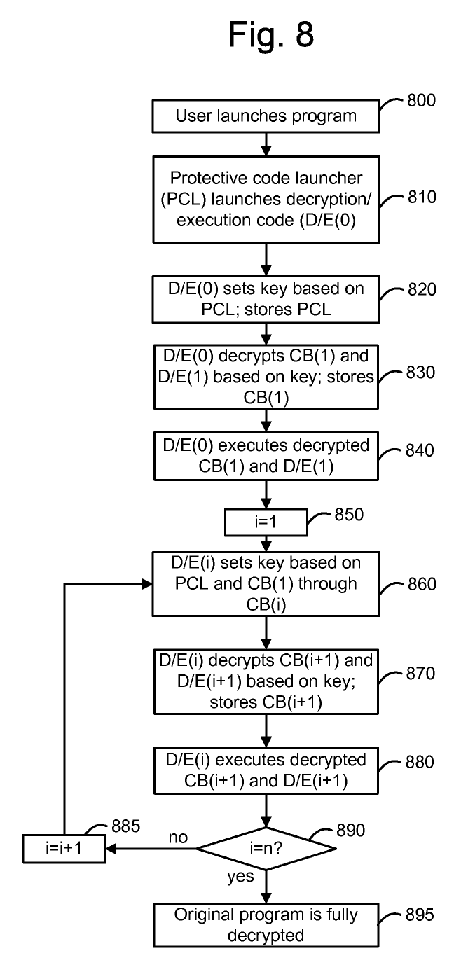

FIG. 9 depicts a flowchart of pre-deployment processing in which runtime data is used in an encryption key. One way of increasing the effectiveness of the protective software can be achieved by including runtime data in the decryption/execution keys. These runtime data may be predetermined by the developer by running the software before applying the protective technique. For example, the runtime data can include one or more variables of the program which are loaded into memory during a runtime of a first code block. These variables can be accessed by reading them to determine their value. A second code block can then be encrypted based on a value of the one or variables as well as based on the first code block, or based solely on the value of the one or variable. For example, a key for encrypting CB(2) can be formed by reading a variable which is loaded when CB(1) is executed and combining this variable value with CB(1). On the other hand, to decrypt CB(2), D/E(1) includes appropriate instructions for accessing the same variable value. For instance, in a graphics program, a variable may be set based on the current code block which is executing, e.g., a paintbrush feature may be selected in which case a variable “paintbrush” is set to 1. The next code blocks can be encrypted/decrypted using this value 1 along with the current code block.

It is also possible for variables from one or more prior code blocks to be used in encrypting a given code block. For example, a key for encrypting CB(3) can be formed using variables which are loaded when CB(1) and CB(2) are executed.

In another approach, the key can be based on the size of the objects in memory, memory addresses, instruction codes, difference in length between memory address of objects, etc. This takes into consideration that the key is predetermined and at runtime the key obtained will match the one with which the encryption was done unless the software has been tampered with. In another approach, which can be used by itself or in combination with other approaches, a key is based on runtime data which includes call stack data. A call stack generally refers to a software stack of functions, including routines, which are used by a running program. The functions are usually listed in the reverse order, from top to bottom, in which they were called. The function at the bottom of the stack is the one currently executing. The program can be run in the pre-deployment phase to determine the call stack functions/values of variables at runtime. One or more of the call stack functions can be used in addition to the associated code block as the key to encrypt the next code block. At runtime, if the hacker modifies the memory directly to remove the call to the shareware nag message, for instance, the call stack and thus the key will be changed so that the next code block cannot be decrypted and executed. Providing an encryption key which is based on combination of the call stack and the code block can thereby pose an additional obstacle to the hacker. This technique also provides protection in scenarios where the hacker keeps another executable made by him running which modifies the memory contents of the actual executable at runtime. Typically this type of hacking is used in games or other software where the hacker finds it difficult to modify the physical file on disk and therefore modifies the part of the program loaded in memory directly.

The developer can use dynamic code execution for this purpose, e.g., based on a technology such as Reflection in the Microsoft .Net Framework. In this approach, the developer can write code, e.g., in D/E(2) to decrypt CB(3) using CB(2) as the key even before CB(2) has been created or the program has been run. For example, D/E(2) can load its own type information at runtime to a string and use it as the key for decrypting CB(3). While the hacker can modify the string to remove the call, this must be done for all the code blocks while also progressively decrypting them. This poses a substantial burden which would probably take more time than actually developing the software. The concept of using System.Reflection of the Microsoft *Net Framework is provided only as an example. Any technique for running compiled/intermediate/source code can be used for executing code dynamically at runtime.

A technique for incorporating runtime data into the decryption/execution keys as discussed above begins at step 900 in a pre-deployment processing of a program. At step 905, the program is run to determine the runtime data. The present example involves four code blocks for simplicity. At step 910, runtime data RT(1) from CB(1), RT(2) from CB(2) and RT(3) from CB(3) are stored. For example, the runtime data can include variables and/or call stack functions as mentioned. At step 915, the decryption/execution code D/E(0) is added to the protective code launcher (PCL). At step 920, the decryption/execution code D/E(1) through D/E(3) is added to the code blocks CB(1) through CB(3), respectively. At step 925, a key is set based on CB(3) and its associated runtime data RT(3) and, at step 930, CB(4) is encrypted using the key. At step 935, a key is set based on CB(2) and its associated runtime data RT(2) and, at step 940, CB(3) and D/E(3) are encrypted using the key. At step 945, a key is set based on CB(1) and its associated runtime data RT(1) and, at step 950, CB(2) and D/E(2) are encrypted using the key. At step 955, a key is set based on PCL and, at step 960, CB(1) and D/E(1) are encrypted using the key. Finally, the pre-deployment processing ends at step 965.

Optionally, the encryption keys may be formed from a hash which uses a combination of code blocks and one or more types of runtime data.

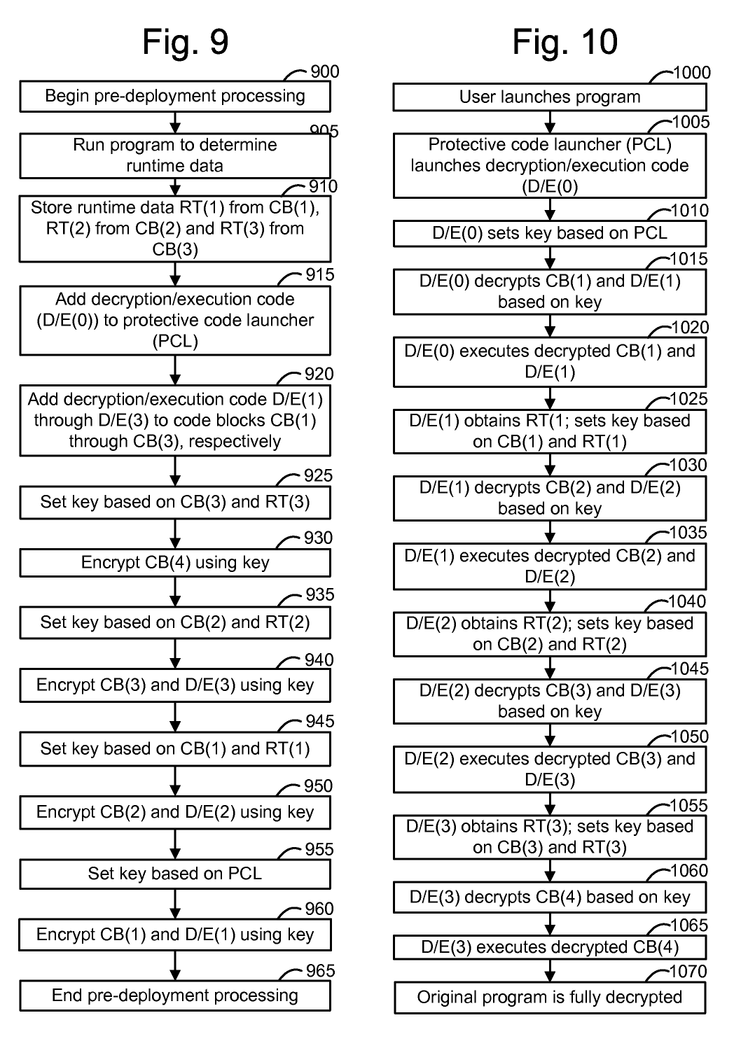

FIG. 10 depicts a flowchart of runtime processing in which runtime data is used in a decryption key. The processing is a counterpart to the processing of FIG. 9. At step 1000, a user launches the protected program, although an automated launching is also possible. At step 1005, in response, the protective code launcher (PCL) launches the decryption/execution code D/E(0). Decryption code of D/E(0) sets a key based on PCL at step 1010 and decrypts CB(1) and D/E(1) based on the key at step 1015, while execution code of D/E(0) executes the decrypted CB(1) and D/E(1) at step 1020. Note that runtime data of the PCL could also be used to encrypt CB(1) and D/E(1) although it is not in the present example. Next, decryption code of D/E(1) obtains the runtime data RT(1), such as by accessing a variable value or call stack data of a runtime of CB(1), which has at least started to execute, and sets a key based on CB(1) and RT(1) at step 1025. The decryption code of D/E(1) decrypts CB(2) and D/E(2) based on the key at step 1030, while execution code of D/E(1) executes the decrypted CB(2) and D/E(2) at step 1035.

At step 1040, decryption code of D/E(2) obtains the runtime data RT(2), and sets a key based on CB(2) and RT(2). The decryption code of D/E(2) decrypts CB(3) and D/E(3) based on the key at step 1045, while execution code of D/E(2) executes the decrypted CB(3) and D/E(3) at step 1050. At step 1055, decryption code of D/E(3) obtains the runtime data RT(3), and sets a key based on CB(3) and RT(3). The decryption code of D/E(3) decrypts CB(4) and D/E(4) based on the key at step 1060, while execution code of D/E(3) executes the decrypted CB(4) at step 1065. At step 1070, the original program is fully decrypted.

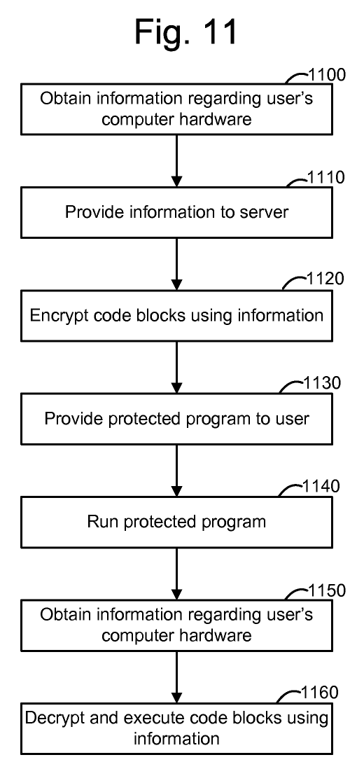

FIG. 11 depicts a flowchart of an anti-piracy process which restricts execution of a program based on computer hardware. In this approach, at step 1100, information from an authorized user's host computer is gathered for use in encrypting one or more code blocks of the protected program at a server on which the protected program is being prepared. In one possible implementation, an executable “A” is provided on the authorized user's computer. For example, executable “A” can be downloaded from a server to the user's computer or read from a local CD-ROM or other interface. Or, executable “A” can be included as part of the operating system of the user's computer. Executable “A” is also protected using the protection technique. Executable “A” collects hardware specific information of the computer, such as a serial number of a hard disk of the computer, in one possible approach. As Executable “A” is also protected, it cannot be modified to provide false information to the server computer. Or, the information can be obtained by software running on a remote server which communicates with the user's computer.

Once the information is gathered, it is provided to the server at step 1110. In one approach, the user manually sends the information to the server. For example, the user can copy and paste the information to a web page which in turns provides the information to the server. Or, the user can write the information to a CD-ROM or an e-mail message and send it to the person/company who manages the server. Or Executable “A” can directly contact the server computer and provide the hardware information it has collected. At step 1120, the protected program (executable “B” which is the actual executable that is being stored/installed/deployed) is prepared by encrypting code blocks using the information which has been obtained. For example, each code block of the program can be encrypted using the previous code block and the information, e.g., a hard disk serial number. At step 1130, the protected program is provided to the user's computer, e.g., via a network download or via a portable storage medium such as a CD-ROM or via Executable “A” which may do this automatically.

At step 1140, when the program (executable “B”) is executed at the user's computer, e.g., during a runtime of the program, the program includes code for obtaining the information regarding the user's computer (step 1150). For example, when D/E(0) executes to decrypt CB(1) and D/E(1), D/E(0) can include instructions for obtaining the information regarding the user's computer, and use the information in the decrypting process. The information can then be stored in memory for use by D/E(1) in decrypting CB(2) and D/E(2) and so forth. Or, D/E(1) can access the information itself from the computer. At step 1160, one or more code blocks of the protected program are decrypted using the information and executed. If a user attempts to run the protected program on another computer, the program will not run because the computer information needed for decrypting is not available or is different.

In one approach, the computer's operating system has a client executable that collects the computer information and sends it to the server. The server can send files (or code blocks) critical for some features of the operating system or the main application that is being executed, by creating them using this technique and using the information collected from the client executable for encryption. By doing this, the program (the critical feature of the operating system or application) can be uniquely locked to a specific computer.

A further variation involves accessing information stored on a portable media for use in decrypting a protected program. For example, a portable media such as a smart card, USB storage devices, RFID media, proximity device or the like can be used to store data which forms all or part of a key for decrypting one or more code blocks. In this approach, the data is provided to the authorized user via the portable media and the user employs the portable media when running the protected program. For example, CB(2) and D/E(2) may be encrypted during the pre-deployment phase using a key which is based on dataX, e.g., some data string. When the user purchases the program at a retail location, for instance, the user is provided with the portable media. The user then interfaces the portable media to the computer host when running the protected program. When executing, D/E(1) accesses the data on the portable media and uses it to form a key for decrypting CB(2) and D/E(2). The same or different data which is stored on the portable media may be used for encrypting different code blocks. In one option, dataX is based on an identifier which is unique to the particular portable storage media, such as a serial number. Or, dataX need not be related to the particular portable storage media so that dataX can be provided on different portable storage media devices.

Executable “A” (also protected using the protection technique) at the computer can collect such data and send it to the server. In response, the server can encrypt the code blocks in the protected program using the data as part of an encryption key and then provide the protected program to the user's computer. When the user subsequently runs the protected program, the data from the portable storage media is again accessed for use in decrypting code blocks. Thus, in one approach, the user first obtains the portable storage media and uses it to subsequently obtain a protected program which is encrypted based on that media. In another approach, the user obtains a particular portable storage media and a corresponding protected program, e.g., via a CD-ROM at a retail location.

Moreover, instead of using computer hardware information for the encryption key, information such as network address information, e.g., IP address, etc., can be used as key. This approach can be used to allow the protected program to run only on a specific network or group of computers. In this approach, the server on which the protected program is prepared can obtain a network address associated with the user's computer when the user's computer connects to the server to download the program. Or, the network address can be provided to the server in various ways as mentioned above in connection with the other computer information.

Alternatively, executable “A” (also protected using the protection technique) at the computer can collect computer information from hardware devices such as video game consoles (e.g., Microsoft XBOX 360™), digital media players (e.g., Microsoft Zune™) and the like. This information may either be a unique piece of information about the hardware such as a serial number and/or it may be just data contained in the hardware. The server can then create a file (or necessary data/stream of data) that can be run on the hardware device using the self-verifying software technique. In this case, the hardware device can be configured with logic for running the file or using the data.

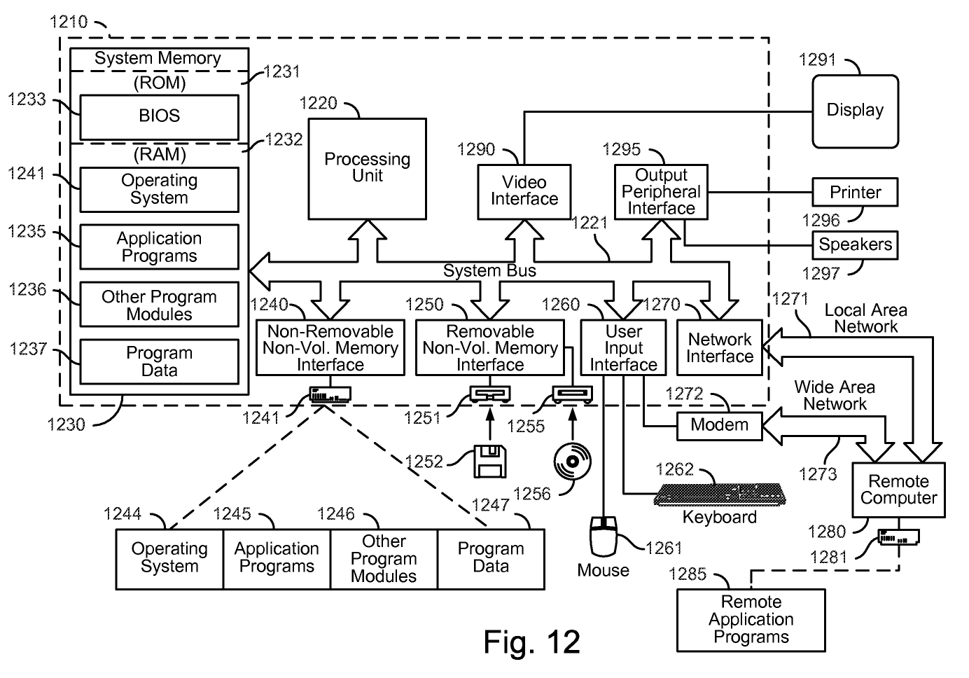

FIG. 12 is a block diagram of computer hardware suitable for implementing embodiments of the invention. An exemplary system for implementing the invention includes a general purpose computing device in the form of a computer 1210. The computer 1210 may represent a server at which a program is modified to add protective software or a computer host at which a user runs a protected program, for instance. Components of computer 1210 may include, but are not limited to, a processing unit 1220, a system memory 1230, and a system bus 1221 that couples various system components including the system memory to the processing unit 1220. The system bus 1221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1210 typically includes a variety of computer readable media. Computer readable media can be any available media that can be accessed by computer 1210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 1230 includes computer storage media in the form of volatile and/or nonvolatile memory such as read only memory (ROM) 1231 and random access memory (RAM) 1232. A basic input/output system 1233 (BIOS), containing the basic routines that help to transfer information between elements within computer 1210, such as during start-up, is typically stored in ROM 1231. RAM 1232 typically contains data and/or program modules that are immediately accessible to and/or presently being operated on by processing unit 1220. By way of example, and not limitation, FIG. 12 illustrates operating system 1234, application programs 1235, other program modules 1236, and program data 1237.

The computer 1210 may also include other removable/non-removable, volatile/nonvolatile computer storage media. By way of example only, FIG. 12 illustrates a hard disk drive 1241 that reads from or writes to non-removable, nonvolatile magnetic media, a magnetic disk drive 1251 that reads from or writes to a removable, nonvolatile magnetic disk 1252, and an optical disk drive 1255 that reads from or writes to a removable, nonvolatile optical disk 1256 such as a CD ROM or other optical media. Other removable/non-removable, volatile/ nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1241 is typically connected to the system bus 1221 through a non-removable memory interface such as interface 1240, and magnetic disk drive 1251 and optical disk drive 1255 are typically connected to the system bus 1221 by a removable memory interface, such as interface 1250.

The drives and their associated computer storage media discussed above and illustrated in FIG. 12, provide storage of computer readable instructions, data structures, program modules and other data for the computer 1210. For example, hard disk drive 1241 is illustrated as storing operating system 1244, application programs 1245, other program modules 1246, and program data 1247. These components can either be the same as or different from operating system 1234, application programs 1235, other program modules 1236, and program data 1237. Operating system 1244, application programs 1245, other program modules 1246, and program data 1247 are given different numbers here to illustrate that, at a minimum, they are different copies. A user may enter commands and information into the computer 1210 through input devices such as a keyboard 1262 and pointing device 1261, commonly referred to as a mouse, trackball or touch pad. Other input devices (not shown) may include a microphone, joystick, game pad, satellite dish, scanner, or the like. These and other input devices are often connected to the processing unit 1220 through a user input interface 1260 that is coupled to the system bus, but may be connected by other interface and bus structures, such as a parallel port, game port or a universal serial bus (USB). A monitor 1291 or other type of display device is also connected to the system bus 1221 via an interface, such as a video interface 1290. In addition to the monitor, computers may also include other peripheral output devices such as speakers 1297 and printer 1296, which may be connected through an output peripheral interface 1295.

The computer 1210 may operate in a networked environment using logical connections to one or more remote computers, such as a remote computer 1280. The remote computer 1280 may be a personal computer, a server, a router, a network PC, a peer device or other common network node, and typically includes many or all of the elements described above relative to the computer 1210, although only a memory storage device 1281 has been illustrated. The logical connections depicted include a local area network (LAN) 1271 and a wide area network (WAN) 1273, but may also include other networks. Such networking environments are commonplace in offices, enterprise-wide computer networks, intranets and the Internet.

When used in a LAN networking environment, the computer 1210 is connected to the LAN 1271 through a network interface or adapter 1270. When used in a WAN networking environment, the computer 1210 typically includes a modem 1272 or other means for establishing communications over the WAN 1273, such as the Internet. The modem 1272, which may be internal or external, may be connected to the system bus 1221 via the user input interface 1260, or other appropriate mechanism. In a networked environment, program modules depicted relative to the computer 1210, or portions thereof, may be stored in the remote memory storage device. By way of example, and not limitation, FIG. 12 illustrates remote application programs 1285 as residing on memory device 1281. It will be appreciated that the network connections shown are exemplary and other means of establishing a communications link between the computers may be used.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A computer-implemented method for protecting software, comprising:
adding decrypting and executing code to a program to be protected, the program includes one code block which is executed during a runtime of the program;
encrypting the one code block using a key which is based partially or totally on another code block of the program to provide an encrypted one code block, the decrypting and executing code includes: (a) code for decrypting the encrypted one code block to provide a decrypted one code block and (b) code for executing the decrypted one code block.

2. The computer-implemented method of claim 1, further comprising:
adding code to the program for launching the decrypting and executing code, the code for launching is executed responsive to the program being launched or a part of the program being executed.

3. The computer-implemented method of claim 2, further comprising:
encrypting the another code block to provide an encrypted another code block, the code for launching includes: (a) code for decrypting the encrypted another code block to provide a decrypted another code block and (b) code for executing the decrypted another code block.

4. The computer-implemented method of claim 1, further comprising:
adding additional decrypting and executing code to the program; and
encrypting a further code block of the program which is executed during a runtime of the program using a key which is based partially or totally on the one code block, to provide an encrypted further code block, the additional decrypting and executing code includes: (a) code for decrypting the encrypted further code block to provide a decrypted further code block and (b) code for executing the decrypted further code block.

5. The computer-implemented method of claim 1, further comprising:
adding additional decrypting and executing code to the program; and
encrypting a further code block of the program which is executed during a runtime of the program using a key which is based partially or totally on the another and one code blocks, to provide an encrypted further code block, the additional decrypting and executing code includes: (a) code for decrypting the encrypted further code block to provide a decrypted further code block and (b) code for executing the decrypted further code block.

6. The computer-implemented method of claim 1, wherein:
the one code block is encrypted using the value of at least one variable or memory location, accessible during a runtime of the program prior to executing the one code block, as the key or part of the key.

7. The computer-implemented method of claim 1, further comprising:
the one code block is encrypted using at least one call stack function of the program which is accessible during a runtime of the program, as the key or part of the key.

8. The computer-implemented method of claim 1, wherein:
the code includes source code in plain text, instructions, byte code, intermediate code or instructions or a combination thereof.

9. The computer-implemented method of claim 1, wherein:
the program includes an executable having data content and logic for accessing the data content.

10. The computer-implemented method of claim 1, wherein:
at least one of the code blocks includes a functionality which requires a user to provide an authorization to use the program.

11. The computer-implemented method of claim 1, wherein: the one code block is executed after the another code block.

12. A computer-implemented method for running protected software, comprising:
receiving a request to launch a program;
based on the request, decrypting an encrypted particular code block and encrypted particular protective code of the program to provide a decrypted particular code block and decrypted particular protective code, respectively;
executing the decrypted particular code block; and
executing the decrypted particular protective code to decrypt an encrypted additional code block of the program, thereby providing a decrypted additional code block, and to execute the decrypted additional code block.

13. The computer-implemented method of claim 12, wherein:
the encrypted additional code block is decrypted using a key which is based partially or totally on at least a portion of the decrypted particular code block.

14. The computer-implemented method of claim 12, further comprising:
executing the decrypted particular protective code to decrypt encrypted additional protective code of the additional code block, to provide decrypted additional protective code; and
executing the decrypted additional protective code to decrypt an encrypted further code block of the program, thereby providing a decrypted further code block, and to execute the decrypted further code block.

15. The computer-implemented method of claim 12, further comprising:
identifying a value of at least one variable or memory location of the program which is accessible during a runtime of the program, the additional encrypted code block is decrypted based partially or totally on the value.

16. The computer-implemented method of claim 12, further comprising:
identifying at least one call stack function of the program which is accessible during a runtime of the program, the additional encrypted code block is decrypted based partially or totally on the at least one call stack function.

17. The computer-implemented method of claim 12, further comprising:
accessing information stored on a portable media for use as a key or part of a key in the encrypting and decrypting of the particular or additional code block.

18. Computer readable media having computer readable software embodied thereon for programming at least one processor to perform a method, the method comprising:
encrypting parts of the software using a key totally or partially based on other parts of the software;
decrypting the encrypted part of the software at runtime to provide a decrypted part of the software; and
executing the decrypted part of the software, where parts of the software include parts of the software in one or more files, or byte code or intermediate code or source code or code blocks or instructions which are executed at runtime.

19. The computer readable media of claim 18, wherein:
the encrypting comprises encrypting parts of the software using a key totally or partially based on a combination of other parts of the software, runtime data, call stack data.

20. The computer readable media of claim 18, wherein:
the encrypting comprises encrypting parts of the software using a key totally or partially based on a combination of two or more of items such as other parts of the software, runtime data, call stack data, hardware information, network information and information from portable media, as the key or part of the key, where parts of the software include parts of the software in one or more files, or byte code or intermediate code or source code or code blocks or instructions which are executed at runtime.
